(19) United States
(12) Patent Application Publication
(10) Pub. No.: US 2018/0203839 A1
(43) Pub. Date: Jul. 19, 2018

(54) FAST PAGE LOADING IN HYBRID APPLICATIONS

(71) Applicant: Microsoft Technology Licensing, LLC, Redmond, WA (US)

(72) Inventors: Dennis Myrén, Seattle, WA (US); Kean Ee Lim, Bellevue, WA (US)

(73) Assignee: Microsoft Technology Licensing, LLC, Redmond, WA (US)

(21) Appl. No.: 15/594,041

(22) Filed: May 12, 2017

Related U.S. Application Data
(60) Provisional application No. 62/445,861, filed on Jan. 13, 2017.

(51) Int. Cl. G06F 17/24; G06F 17/22

(52) U.S. Cl. CPC G06F 17/248; G06F 17/2247

(57) ABSTRACT

Examples of the present disclosure relate to systems and methods for providing fast page loading in hybrid applications. In an example, a hybrid application may include a native component and a web-based component. To improve performance, the hybrid application may cache the web-based component, which may in turn cache a template page. The template page may include web resources and may be updated using an in-place update, such that content may be updated without performing a full page reload. The template page may comprise a request handler component, which may receive a request for a web resource, determine that the web resource may be loaded within the template page, and request the web resource. The request handler component may then update the template page with content based on a received response. If the components are unavailable, the web resource may be loaded normally in the web-based component.

### BACKGROUND

Hybrid applications may include a plurality of components, wherein each component may provide different functionality within the application. Different components may be used within the hybrid application due to unique characteristics or benefits provided by each component. As an example, a native component may be used for performance, local hardware and storage access, and to provide device-specific features. By contrast, a web-based component may be used to reduce the cost of cross-platform development and provide greater flexibility when publishing updates to the application. However, such web-based components may operate more slowly than native components. As a result, web-based functionality offered by the hybrid application may appear slow or unresponsive, especially as compared to functionality provided by native components.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure relate to systems and methods for providing fast page loading in hybrid applications. In an example, a hybrid application may include functionality provided by a plurality of components. One component may be a native component, while another may be a web-based component. As an example, each component may provide user interface elements in a graphical user interface (GUI) within the hybrid application. To improve performance, the hybrid application may cache the web-based component, which may in turn cache a template page. The template page may be comprised of one or more web resources. Further, the template page may permit an in-place update to be performed within the web-based component, such that content may be added to the template page without needing to perform a full page load of a web resource.

The template page may comprise a request handler component, which may receive a request for a web resource (e.g., from the mobile application or from the native component). The request handler component may determine that the web resource may be loaded using the template page. As a result, the request handler may request the web resource, receive a response from a server, and update the template page to contain the received content. If the request handler component or web-based component is unavailable or is not cached, the web resource may be loaded normally in the web-based component.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for performing fast page loading in a hybrid application.

FIGS. 2A and 2B illustrate an overview of example systems for performing fast page loading in a hybrid application.

FIG. 3 illustrates an overview of an example method for performing fast page loading in a hybrid application.

FIGS. 4A and 4B illustrate an overview of example methods for performing fast page loading in a hybrid application.

FIG. 5 is a block diagram illustrating example physical components of a computing device with which aspects of the disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

FIG. 8 illustrates a tablet computing device for executing one or more aspects of the present disclosure.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

The present disclosure provides systems and methods for performing fast page loading in hybrid applications. A hybrid application may include a plurality of components, and each component may be written using different computing languages, generated using different frameworks, or executed by different processes, among other technologies. As an example, a hybrid application may include a native component (e.g., written in a computing language such as C, C++, Objective-C, Swift, etc.) and a web-based component (e.g., written in a web-language, such as HTML, JavaScript, CSS, PHP, etc., retrieved from a webserver, and displayed in the hybrid application). One of skill in the art will appreciate that a variety of techniques, languages, and frameworks may be part of a hybrid application without departing from the spirit of this disclosure.

In some examples, components comprising a hybrid application may be used to perform different tasks based on characteristics unique to each component, including, but not limited to performance considerations, development costs, or security features. As discussed above, a hybrid application may include a native component and a web-based component. The native component may be used to provide device integration (e.g., access locally-stored files, interact with specific hardware functionality, etc.), display graphical user interface (GUI) elements, and process user inputs (e.g., handle user navigation, interpret voice input, etc.), among other functions. By contrast, the web-based component may access, display, and interact with remote resources (e.g., a web page or a web application comprising images, videos, style sheets, or JavaScript code, among other remote resources). As such, the web-based component may be used to reduce development costs associated with cross-platform development, provide rapid deployment, and retain control over certain aspects of the hybrid application.

Unfortunately, despite the benefits discussed above, hybrid applications may present certain tradeoffs. In an example, a web-based component may exhibit slower execution times and be less responsive than a native component. As a result, functionality provided by the native component of a hybrid application may appear to perform better or be more responsive than functionality provided by the web-based component. Thus, while the web-based component may offer reduced development costs and greater flexibility, content provided by the web-based component may be less responsive because resources associated with the content may be generated or stored at a location that is remote from the hybrid application. Aspects disclosed herein relate to improving the performance characteristics of such components by caching at least a part of the component, detecting that the component is cached, and using the cached component in such a way so as to reduce the overhead (e.g., processing time, remote resource requests, etc.) of the component when executing in the hybrid application.

A hybrid application may cache one or more components in order to reduce the amount of processing time required by the hybrid application and/or other components. Caching a component may comprise performing one or more actions in advance of, or in preparation for, an event (e.g., a user interaction, the expiration of a timer, the receipt of an indication, etc.). The result of the one or more actions may be stored (e.g., in a temporary location, on a storage device or storage system, in system memory, etc.) by the hybrid application and retrieved when needed (e.g., once the event occurs, in response to a received indication, etc.). In some examples, the hybrid application may cache one or more components when the hybrid application is launched. In another example, the hybrid application may cache one or more components after an initial action (e.g., in response to a first event, caching may occur in preparation for a potential second event).

In other examples, a component itself may perform caching (e.g., of one or more page features, remote resources, etc.). In one example, a “template” resource, such as a web page, an image, a JavaScript document or library, etc., may be loaded by a component, wherein the template resource comprises one or more other resources that are typically used by the component to perform operations or that are typically loaded by other resources associated with the template resource. The associated resources and the template resource may share common features, such as a common design, layout, library, or framework, among other features. As a result, loading the template resource may cause other resources and features to be cached before a receiving a request for an associated resource. For instance, some resources may be tenant-specific or have tenant-specific shared page features, such as a common framework. Accordingly, a template may be created that has the shared page features. As such, upon loading a new tenant-specific resource, only the content that differs from the shared page features needs to be loaded into the template, which reduces the time required to present the page to the user.

As an example, a web-based component may load a template page, which may cause one or more resources, including, but not limited to, JavaScript libraries, images, or documents, to be downloaded and stored in preparation for a web resource request that may require or rely on the one or more downloaded resources. As a result of loading the template page, a blank HTML document object model (DOM) may be available for use, wherein frameworks or libraries may have been compiled, stylesheets may have been loaded and evaluated, and images may have been cached, among other preparations. Web pages associated with the template page may be loaded using the blank DOM, such an in-place update may be performed by updating the DOM to contain content and other information from an associated page. In some examples, the template page and associated pages may be tenant-specific resources, in that they may be associated with a web page or web application of the tenant. The template page and associated pages may be Modern Pages utilized by MICROSOFT SHAREPOINT.

As compared to traditional hybrid applications, caching one or more resources for a component may significantly reduce the amount of processing time that the component uses to process a request. As an example, while a web-based component may take seven seconds to complete a request, caching may halve the processing time to approximately four seconds or less. Additionally, caching a template page in a web-based component in order to perform an in-place update for a requested resource may further reduce the processing time from approximately four seconds to less than one second. Thus, as compared to a traditional hybrid application, aspects described herein may provide at least a seven-fold performance increase.

The plurality of components, such as the native component, the web-based component, and the request handler component, comprising a hybrid application may interact with each other, such that they provide a seamless user experience. In one example, components may exchange state information and other data. In another example, one component may be able to activate another component, such that the other component may be visually presented in the GUI of the hybrid application as a result of a provided indication. One of skill in the art will appreciate that any interaction between components may be provided by a hybrid application without departing from the spirit of this disclosure.

A variety of mechanisms may be used by the plurality of components to interact with one another and a user, including, but not limited to, an application programming interface (API), a uniform resource identifier (URI) or uniform resource locator (URL) call back scheme, or via HTML5 Window.postMessage( ) function calls. In some examples, a cached component may be available to other components such that other components may interact with the cached component even though the cached component has not yet been invoked by the hybrid application or its components. A component may interact with the cached component to determine whether it is available for processing or to determine what resources are loaded or available, among others. Similarly, the cached component may provide an indication to the hybrid application or to other components relating to its availability or capabilities, among others.

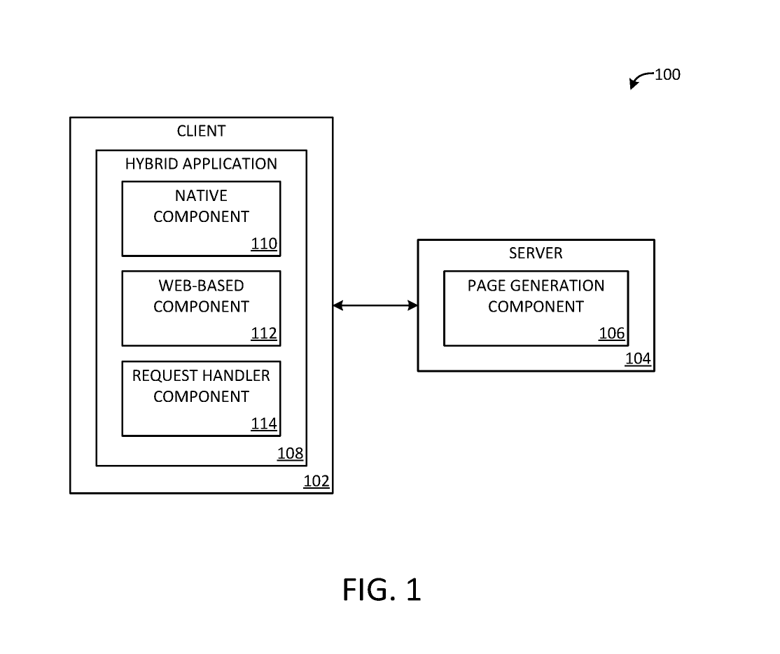

FIG. 1 illustrates an overview of an example system 100 for performing fast page loading in a hybrid application. System 100 is comprised of client 102 and server 104. In an example, client 102 and server 104 may each be a computing device, including, but not limited to, a personal computing device, a tablet computing device, a mobile computing device, or a distributed computing device. In some examples, server 104 may be a tenant in a distributed computing environment. Client 102 may communicate with server 104 (e.g., using a wireless or wired network).

Server 104 may comprise page generation component 106. Page generation component 106 may generate web pages in response to access requests received by server 104. In an example, server 104 may use page generation component 106 to provide a web application or web service (e.g., MICROSOFT SHAREPOINT, MICROSOFT OFFICE 365, MICROSOFT OUTLOOK, GOOGLE GMAIL, etc.) to one or more clients (e.g., client 102). In some examples, page generation component 106 may be used to generate web pages for multiple tenants in a shared hosting environment. In other examples, there may be multiple page generation components, wherein each page generation component may generate web pages for one or more tenants of the shared hosting environment.

Client 102 may comprise hybrid application 108. Hybrid application 108 may, at least in part, be a native application executing on client 102. Hybrid application may comprise native component 110, web-based component 112, and request handler component 114. The request handler component 114 may also be referred to herein as a “router” component. In some examples, web-based component 112 may include request handler component 114. Native component 110 may be a component that client 102 is capable of executing natively (e.g., without a virtual machine or a language interpreter, etc.). Native component 110 may provide a variety of functionality, including, but not limited to, generating or rendering GUI elements, communicating with the hardware components of client 102, and accessing files stored locally on client 102. In some examples, native component 110 may issue one or more requests for a resource provided by server 104 (e.g., using page generation component 106), which may be displayed by hybrid application 108 on client 102 using web-based component 112.

Web-based component 112 may access remote resources (e.g., web resources provided by server 104 using page generation component 106). Web-based component 112 may provide one or more elements for display within the GUI of hybrid application 108, such that a user may interact with elements displayed by web-based component 112. In an example, web-based component 112 may receive input from the user and, based on the received input, may perform local operations (e.g., using a scripting language executed by web-based component 112), transmit data to server 104, or provide an indication to another component (e.g., native component 110 or request handler component 114) of hybrid application 108, among other operations. In some examples, native component 110 may perform operations and display GUI elements alongside web-based component 112, such that each component may be used concurrently by hybrid application 108. As an example, native component 110 may provide a header, a footer, and navigation for hybrid application 108, while web-based component 112 may receive information from native component 110 and display content within hybrid application 108. In some examples, web-based component 112 may receive information from native component 110 or request handler component 114, and vice versa.

Request handler component 114 may communicate with hybrid application 108 and with components 110-112. In some examples, request handler component 114 may be included in, or implemented by, a component, such as web-based component 112. Request handler component 114 may intercept or receive an indication from native component 110 or web-based component 112, including, but not limited to, a request for a resource (e.g., a web resource, a document, etc.) or a status update request. The indication may be provided using an API, a callback, or another method. Based on the indication, request handler component 114 may determine whether a web request can be processed by web-based component 112 and, if so, provide content to web-based component 112 which may be used to load and display content related to the requested web resource. In some examples, request handler component 114 may implement a protocol that may be used by other components to communicate with request handler component 114.

As an example, request handler component 114 may listen for indications using a “router://” protocol, which may be followed by a resource or a reference to a resource (e.g., using a URL, a URI, etc.), among other data. An indication may be provided using an API, a URL or URI scheme, among other methods. Request handler component 114 may then evaluate the indication to determine whether the indication should be routed or what action should be performed. Evaluating the indication may comprise accessing at least a portion of the resource (e.g., a header, the first half of the resource, etc.) or metadata associated with the resource. In another example, the indication may be evaluated based on pattern matching wherein the provided data is compared against one or more pattern matching rules to determine what action should be taken. One of skill in the art will appreciate that any number of techniques or different protocols may be used to evaluate the indication and determine a subsequent action.

In some examples, hybrid application 108 may cache web-based component 112 when hybrid application 108 is first loaded by client 102. Caching web-based component 112 may comprise initializing web-based component 112, such that web-based component 112 may access one or more web resources (e.g., as may be provided by server 104 and page generation component 106) and store them for future use. In some examples, web-based component 112 may access a template page, which may be a tenant-specific web resource such as a Modern Page. The template page may include one or more resources required by a web page or web application but may not yet have content loaded. In some examples, request handler component 114 may be aware of the state of one or more components (e.g., whether a component is loaded or cached, whether web-based component 112 has loaded one or more resources, etc.). Request handler component 114 may be loaded as a result of web-based component 112 loading the blank page, and request handler component 114 may later determine whether web-based component 112 is available to perform an in-place update to process a web request.

When loaded by client 102, hybrid application 108 may display a GUI. The GUI may comprise elements that may be provided by native component 110, including, but not limited to, a header, a footer, and a navigation pane. In some examples, native component 110 may also display content in a body element. The displayed elements may comprise one or more references that, when selected by a user or in response to another event, may invoke a different component (e.g., web-based component 112 and/or request handler component 114) of hybrid application 108.

When such an element is selected, it may be determined whether web-based component 112 is available to process the indication. In some examples, web-based component 112 may not have been previously cached or may no longer be available. As a result, web-based component 112 may be loaded and used to process the indication. Similarly, if request handler component 114 is unavailable but web-based component is loaded, web-based component 112 may be used to process the indication. Processing the indication may comprise retrieving and displaying one or more resources of the indication.

In some examples, it may be determined that request handler component 114 is available to process the indication. As a result, request handler component 114 may receive the indication (e.g., using an API, protocol, etc.) and determine whether the indication can be routed (e.g., using pattern matching or other analysis, as described herein). In an example, request handler component 114 may determine that the indication comprises a request for a web resource that is associated with a template page that was previously loaded. The template page and requested web resource may be part of a web application (e.g., they may each be Modern Pages within MICROSOFT SHAREPOINT or other resources for which a template may be created). In another example, request handler component 114 may also evaluate the state of web-based component 112. If request handler component 114 determines that the indication may be processed by web-based component 112 (e.g., as an in-place update), it may provide an indication to web-based component 112.

In an example, request handler component 114 may retrieve content associated with the indication and provide the content to web-based component 112 to load. Further, web-based component 112 may have a template page loaded, such that the content may be processed by updating the template page (e.g., the cached blank DOM, as described above) with abridged content (e.g., which may exclude at least one of a header, a footer, a navigation pane, etc.). As a result, when web-based component 112 receives the content from request handler component 114, it may perform an in-place update of the GUI to load the content associated with the indicated web resource, while using locally cached resources for other aspects of the web application. This may reduce the computational overhead associated with performing a normal page load using web-based component 112. In some examples, while web-based component 112 may not receive certain interface elements associated with the web resource, web-based component 112 may still update or otherwise modify other elements of the GUI (e.g., by changing a URL displayed in a title bar, updating a navigation pane accordingly, etc.).

In some examples, server 104 or page generation component 106 may, when receiving a request for a web resource from request handler component 114, detect that it may be possible to send a response comprising an abridged representation of the web resource, wherein the abridged representation may omit a header, a footer, or a navigation pane, among other elements. In an example, the abridged representation may be provided in a format other than the computing language of the regular, unabridged page (HTML, JSON, XML, etc.). Additionally, the abridged representation may comprise additional information, including, but not limited to, a manifest of additional resources that may be loaded when displaying the web resource (e.g., an additional JavaScript library, image resources, etc.) or the additional resources themselves. Web-based component 112 or request handler component 114 may then use this information to load additional resources that may not have been previously cached.

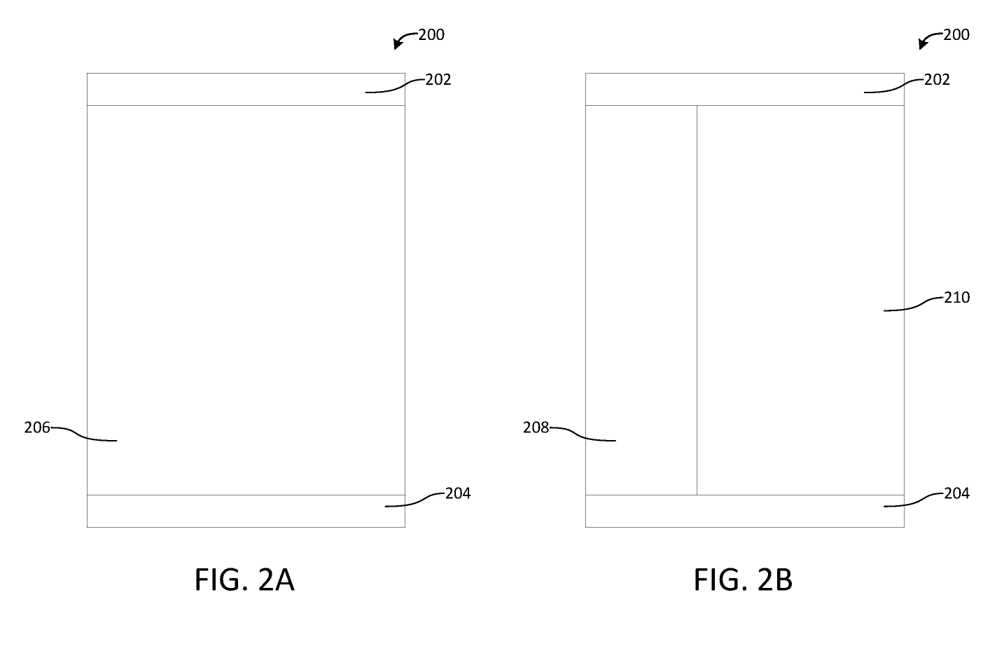

FIG. 2A illustrates an overview of an example system 200 for performing fast page loading in a hybrid application. System 200 may be comprised of header 202, footer 204, and body 206. System 200 may be displayed on a computing device, such as client 102 in FIG. 1. System 200 may be a hybrid application, wherein at least one of header 202, footer 204, and body 206 are GUI elements provided by a native component (e.g., native component 110 in FIG. 1). In an example, header 202 and footer 204 may each provide navigation elements (e.g., a title bar, a URL bar, etc.), an information display, or other visual elements. Body 206 may be used by the native component to display content or information to a user, including, but not limited to, text data, image data, video data, or computer-generated renderings. Native component may update the display of header 202, footer 204, or body 206 based on an event (e.g., an interaction received from the user, the expiration of a timer, an indication received from another component or computing device, etc.).

FIG. 2B illustrates an overview of an example system 200 wherein a web-based component has been activated. The web-based component (e.g., web-based component 114) may have been activated in response to an indication received from the native component of the hybrid application. Similar to FIG. 2A, the native component may provide header 202 and footer 204. Navigation pane 208 may also be provided by the native component. However, body 210 may be provided by the web-based component, wherein one or more web resources may be retrieved and displayed within the GUI of the hybrid application. The web-based component may interact with the native component in order to update at least part of header 202, footer 204, or navigation pane 208. As an example, as different web resources are displayed using body 210 by the web-based component, navigation elements (e.g., back and forward buttons, a URL bar, a page title, etc.) or navigation pane 208 may be updated accordingly.

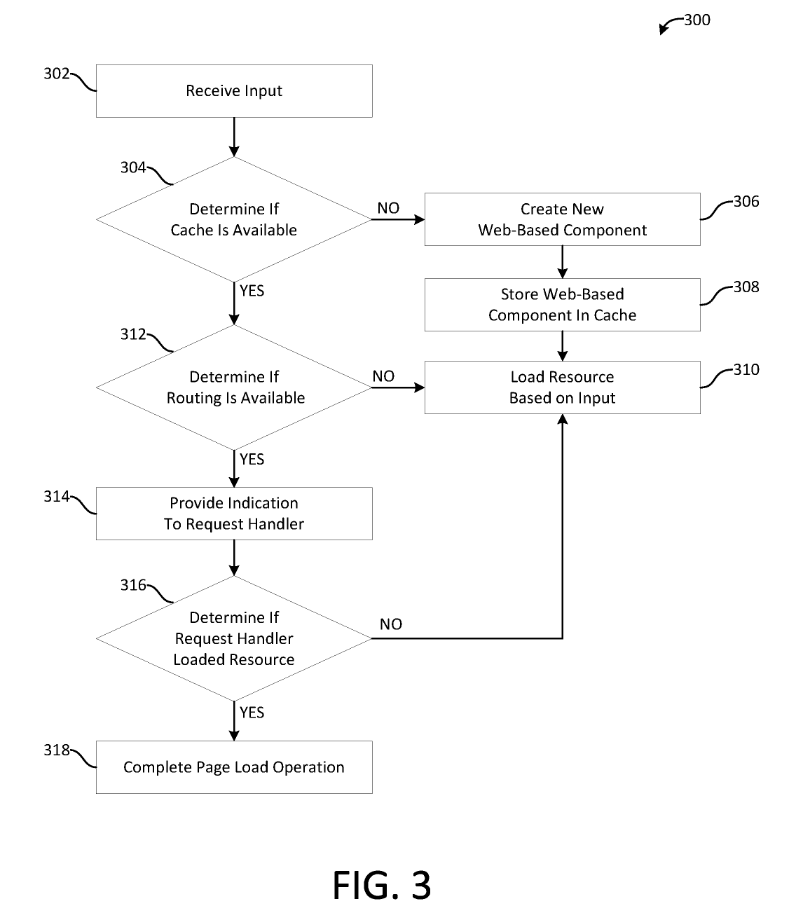

FIG. 3 illustrates an overview of an example method 300 for performing fast page loading in a hybrid application. Method 300 may be performed by a computing device, such as client 102 in FIG. 1. In some examples, method 300 may be performed by a hybrid application, such as hybrid application 108 in FIG. 1. Method 300 begins at operation 302, where an input may be received. The input may be an indication received from a component of a hybrid application, such as native component 110 in FIG. 1. The indication may comprise a request for a web resource.

Moving to operation 304, a determination may be made whether a cache is available. The determination may comprise evaluating whether a cached component (e.g., web-based component 112 in FIG. 1) is available to handle the received input. If it is determined that the cache is not available, flow branches NO to operation 306, where a new web-based component may be created. Creating the web-based component may comprise loading and caching a template page or other web resource within the web-based component. At operation 308, the new web-based component may be stored in cache. The web-based component may be cached in system memory, on a storage device, or using any other caching technique. At operation 310, the web resource may be loaded in the web-based component. Loading the web resource may comprise communicating with a remote server (e.g., server 104 in FIG. 1) or other computing device. In an example, multiple other web resources may be loaded as a result of loading the web resource. Flow terminates at operation 310.

If, however, it is determined that a cache is available, flow branches YES to operation 312, where a determination is made whether routing is available. The determination may comprise evaluating whether a request handler (e.g., request handler component 114 in FIG. 1) exists in system memory, whether a global variable or function call is available, among other techniques. If it is determined that routing is not available, flow branches NO to operation 310, where the resource may be loaded based on the received input as discussed above. Flow terminates at operation 310.

If, however, it is determined that routing is available, flow branches YES to operation 314, where an indication may be provided to the request handler. The indication may be provided using an API, URL or URI scheme, or protocol, among other mechanisms. In response to receiving the indication, the request handler may evaluate the received indication according to aspects disclosed herein (e.g., using pattern matching, accessing at least a portion of a resource associated with the indication, etc.). The request handler may then determine whether the resource may be loaded in the cached web-based component. In an example, this determination may comprise determining that the requested resource is associated with the template page (e.g., that both the requested resource and the template page are part of a web application, such as Modern Pages within MICROSOFT SHAREPOINT). If the cached web-based component may be used to load the resource, request handler may use the cached web-based component to load the resource. As discussed above, an abridged representation of the web resource may be received from the server, which may then be used to perform an in-place update of the template page loaded in the web-based component.

Moving to operation 316, a determination may be made whether the request handler loaded the resource. The determination may be based on receiving a response to the indication that was provided to the request handler at operation 314 or receiving an indication from the request handler via an API or other callback mechanism as disclosed herein. If the request handler did not load the resource, flow branches NO to operation 310, where the resource may be loaded based on the received input as discussed above. Flow then terminates at operation 310. If, however, the request handler loaded the resource, flow branches YES to operation 318, where the page load operation is complete. In some examples, the mobile application may perform one or more actions as a result of completing the page load operation, including, but not limited to, updating an element of its GUI, activating an element provided by a component, or collecting information relating to the input. Flow terminates at operation 314.

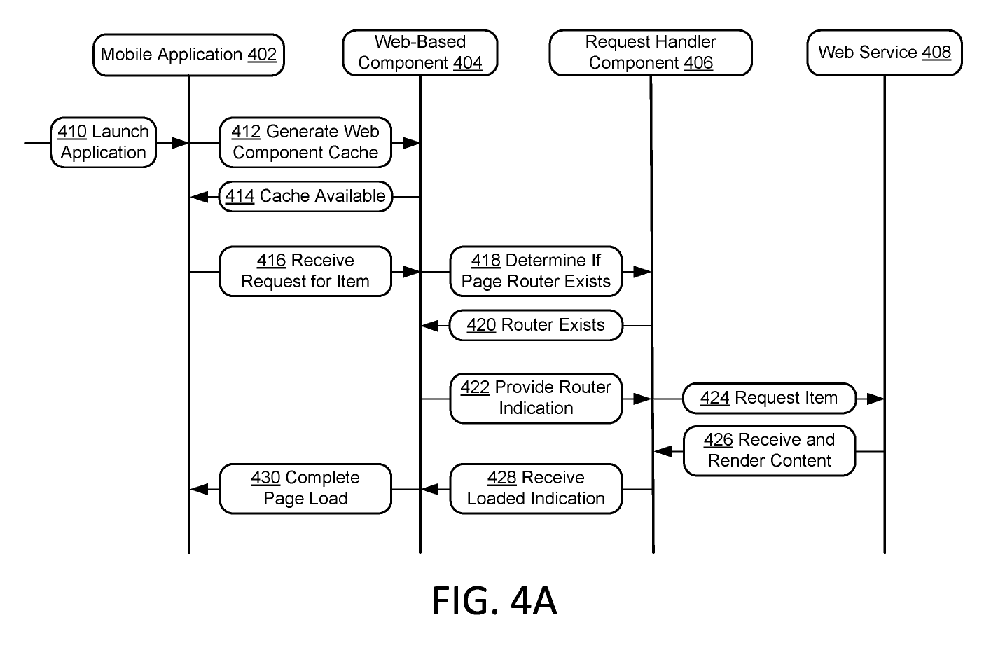

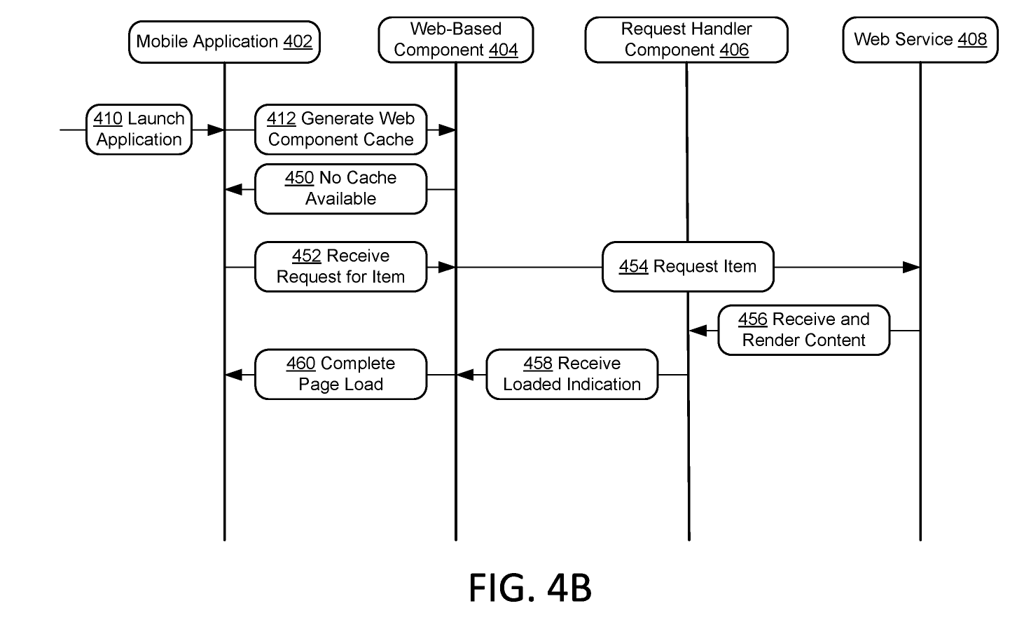

FIG. 4A illustrates an overview of an example method for performing fast page loading in a hybrid application. The method may be performed by mobile application 402, web-based component 404, request handler component 406, and web service 408. Mobile application 402 may be a hybrid application (e.g., hybrid application 108 in FIG. 1) executing on a user device (e.g., client 102), wherein a native component (not pictured) of mobile application 402 may interact with web-based component 404. Web-based component 404 may be a web-based component (e.g., web-based component 112 in FIG. 1) used by mobile application 402 to display one or more resources (e.g., as provided by web service 408). Mobile application 402 may interact with web-based component 404 using an API, a callback scheme, or other communication mechanism. Request handler component 406 (e.g., request handler component 114 in FIG. 1) may be loaded by web-based component 404 and used to process and load requests for web resources. Web service 408 may be a server or other computing device (e.g., server 104 in FIG. 1) that may provide one or more web pages or web applications to web-based component 404 and request handler component 406.

The method begins at operation 410, where mobile application 402 may be launched. At operation 412, mobile application 402 may generate a cache of a web-based component (e.g., web-based component 404). The web-based component may be loaded such that one or more web resources are cached by the web-based component. In an example, web-based component may load and cache a template page as disclosed herein. In another example, web-based component 404 may load a request handler component (e.g., request handler component 406). Moving to operation 414, an indication may be provided to mobile application 402 that a cache of web-based component 404 is available.

At operation 416, a request may be received for an item (e.g., a web or other remote resource), causing an indication to be provided to web-based component 404. The request may be received as a result of a user interaction with mobile application 402 or other event. Moving to operation 418, a determination may be made whether a page router exists (e.g., request handler component 406). This determination may comprise evaluating a global variable, determining whether the router exists in system memory, among other techniques as disclosed herein. At operation 420, it is determined that the router exists.

As a result, an indication may be provided to request handler component 406, wherein the indication comprises information relating to the request for the item received at operation 416. The indication may conform to a protocol (e.g., the “router://” protocol), invoke an API function, or utilize a callback scheme, among other mechanisms. Request handler component 406 may receive the indication and may, at operation 424, request the indicated item from web service 408. Web service 408 may determine that the request was generated by request handler component 406 (e.g., due to a specific user-agent string, a GET or POST variable provided with the request, etc.) and may provide an abridged representation of the item to request handler component 406. At operation 426, request handler component 406 may receive the abridged content and render it accordingly. In an example, request handler component 406 may perform an in-place update of the template page that was loaded by web-based component 404 using the received content. In some examples, request handler component 406 may also update other aspects of a GUI provided by web-based component 404 or displayed by mobile application 402, including, but not limited to, a URL bar, a title bar, or navigation elements (e.g., a back and forward button, a navigation pane, etc.).

At operation 428, web-based component 404 may receive an indication that the item was loaded by request handler component 406. As a result of the indication, web-based component 404 may provide an indication that the page load is complete to mobile application 402 at operation 430. In some examples, mobile application 402 may perform one or more actions as a result of receiving the indication, including, but not limited to, updating an element of the GUI, activating an element provided by a component (e.g., web-based component 404), or collecting information relating to the request. Flow ends at operation 430.

FIG. 4B illustrates an overview of an example method for performing fast page loading in a hybrid application. The method may be performed by mobile application 402, web-based component 404, request handler component 406, and web service 408. Mobile application 402 may be a hybrid application (e.g., hybrid application 108 in FIG. 1) executing on a user device (e.g., client 102), wherein a native component (not pictured) of mobile application 402 may interact with web-based component 404. Web-based component 404 may be a web-based component (e.g., web-based component 112 in FIG. 1) used by mobile application 402 to display one or more resources (e.g., as provided by web service 408). Mobile application 402 may interact with web-based component 404 using an API, a callback scheme, or other communication mechanism. Request handler component 406 (e.g., request handler component 114 in FIG. 1) may be loaded by web-based component 404 and used to process and load requests for web resources. Web service 408 may be a server or other computing device (e.g., server 104 in FIG. 1) that may provide one or more web pages or web applications to web-based component 404 and request handler component 406.

The method begins at operation 410, where mobile application 402 may be launched. At operation 412, mobile application 402 may generate a cache of a web-based component (e.g., web-based component 404). However, at operation 450, it may be determined that no cache is available. The cache may be unavailable because the web-view component failed to load, or because the web-view component no longer has one or more previously-cached resources in its cache (e.g., a template page, a required JavaScript library, etc.). As a result, when a request for an item is received at operation 452, web-based component 404 may not use request handler component 406 as was the case in FIG. 4A. Instead, in operation 454 web-based component 404 may transmit a request for the item directly to web service 408.

Upon receiving the request, web service 408 may determine that the request was generated by a web-based component without use of a request handler component (e.g., due to the absence of a specific user-agent string, a GET or POST variable provided with the request, etc.) and may provide an full representation of the item (e.g., containing a header, a footer, or a navigation pane, among other elements) to request handler component 406. In some examples, no determination may be made by web service 408 and the full representation of the item may be provided by default. At operation 456, request handler component 406 may be loaded as a result of receiving the content. In an example, request handler component 406 may be included within the received content (e.g., as a JavaScript library, a computing framework, or other computing resource). Further, web-based component 404 may download web resources associated with the received content, including, but not limited to, images, script resources, and style sheets. Contrary to the flow illustrated in FIG. 4A, no in-place update may be performed because the template page was not previously loaded by web-based component 404. In some examples, web-based component 404 and/or request handler component 406 may update other aspects of a GUI provided by web-based component 404 or displayed by mobile application 402, including, but not limited to, a URL bar, a title bar, or navigation elements (e.g., a back and forward button, a navigation pane, etc.).

At operation 458, web-based component 404 may receive an indication that the item was loaded by request handler component 406. As a result of the indication, web-based component 404 may provide an indication that the page load is complete to mobile application 402 at operation 460. In some examples, mobile application 402 may perform one or more actions as a result of receiving the indication, including, but not limited to, updating an element of the GUI, activating an element provided by a component (e.g., web-based component 404) or collecting information relating to the request. Flow ends at operation 460.

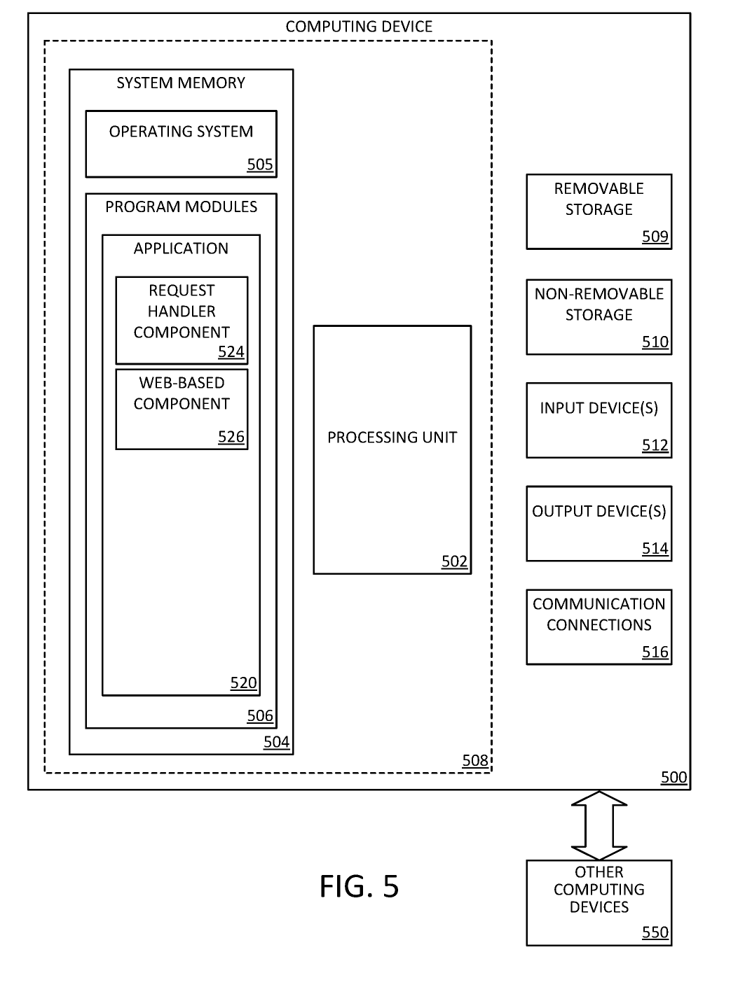

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above, including the client 102 and server 104. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories. The system memory 504 may include an operating system 505 and one or more program modules 506 suitable for performing the various aspects disclosed herein such as a request handler component 524 and a web-based component 526. The operating system 505, for example, may be suitable for controlling the operation of the computing device 500. Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

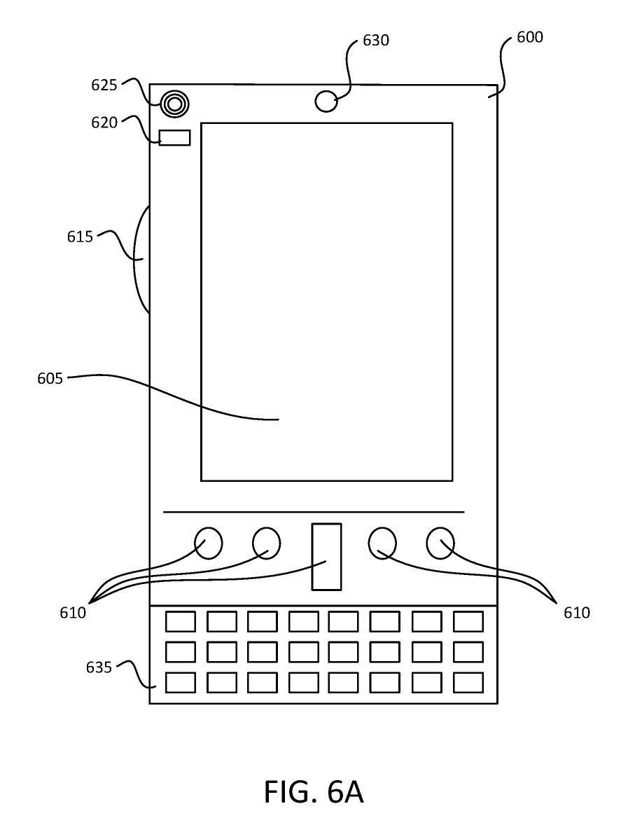

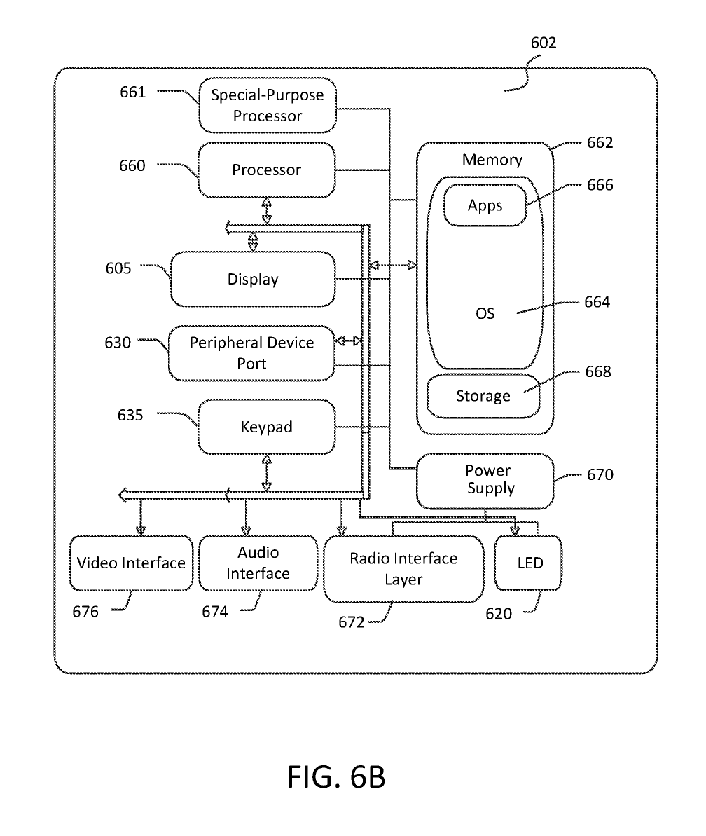

FIGS. 6A and 6B illustrate a mobile computing device 600, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 6A, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one embodiment, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600 described herein (e.g., search engine, extractor module, relevancy ranking module, answer scoring module, etc.).

The system 602 has a power supply 670, which may be implemented as one or more batteries. The power supply 670 might further include an external power source, such as an AC adapter or a powered docking cradle that supplements or recharges the batteries.

The system 602 may also include a radio interface layer 672 that performs the function of transmitting and receiving radio frequency communications. The radio interface layer 672 facilitates wireless connectivity between the system 602 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio interface layer 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio interface layer 672 or via a distributed computing network. Similarly, such data/information may be readily transferred between computing devices for storage and use according to well-known data/information transfer and storage means, including electronic mail and collaborative data/information sharing systems.

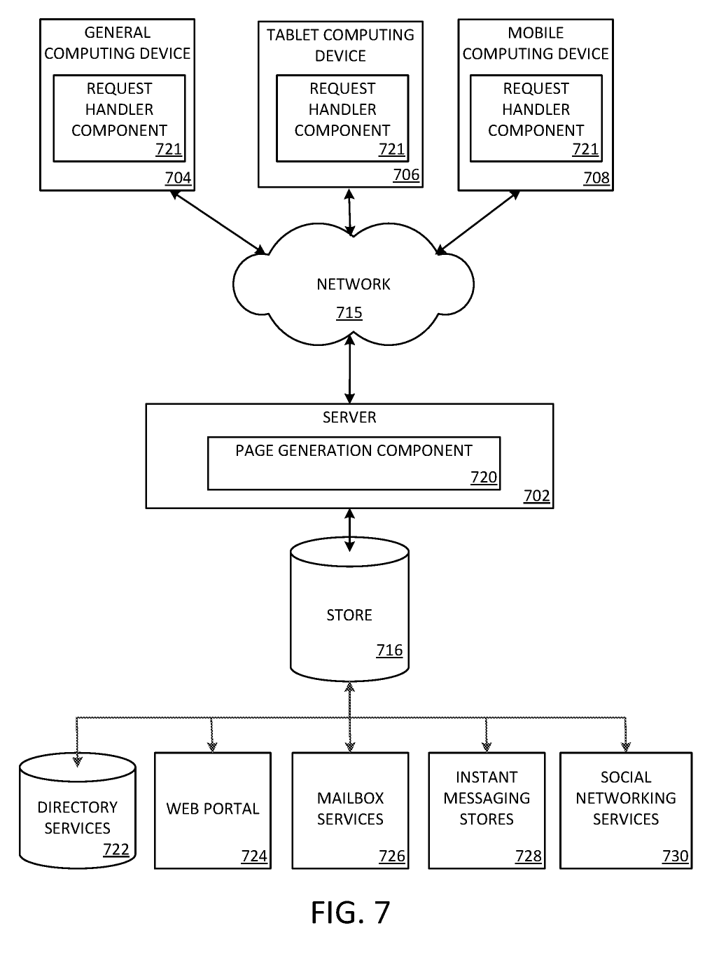

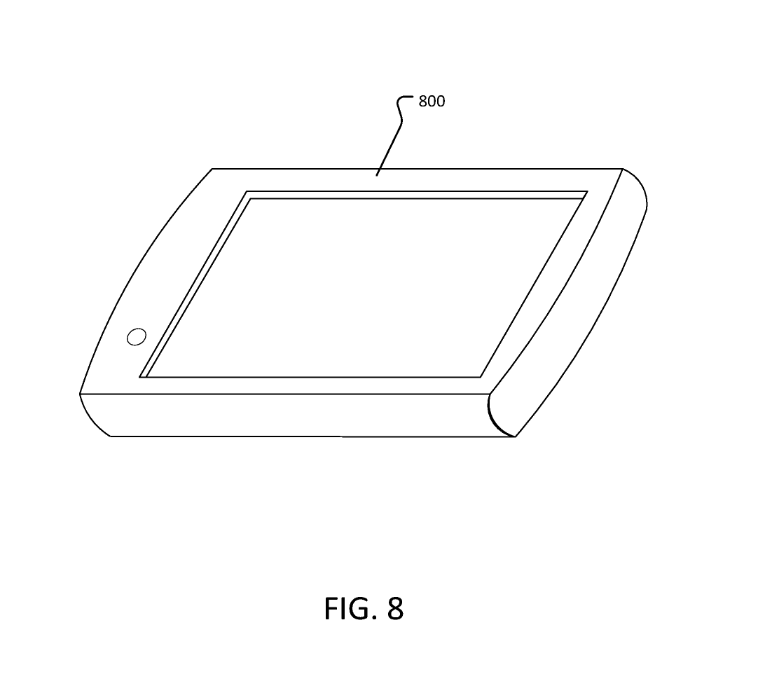

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 722, a web portal 724, a mailbox service 726, an instant messaging store 728, or a social networking site 730. Request handler component 721 may be employed by a client that communicates with server device 702, and/or page generation component 720 may be employed by server device 702. The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these embodiments of the computing devices may obtain content from the store 716, in addition to receiving graphical data useable to be either pre-processed at a graphic-originating system, or post-processed at a receiving computing system.

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and a memory storing instructions that when executed by the at least one processor perform a set of operations. The set of operations comprises: caching, in a web-based component having a request handler, a template page comprising one or more web resources; receiving, by a hybrid application, a request for a resource; determining, by the request handler, whether the request for the resource may be processed using the template page in the web-based component; when it is determined that the request may be processed: requesting the resource; receiving, in response to the request, content associated with the resource; updating the template page using the received content; and displaying, by the web-based component in the hybrid application, the updated template page using at least one of the one or more web resources cached by the web-based component. In an example, determining whether the request may be processed comprises evaluating the request for the resource using pattern matching. In another example, updating the template page comprises performing an in-place update of the template page based on at least part of the received content. In a further example, the received content associated with the resource comprises a part of the requested resource. In yet another example, the content associated with the resource comprises a manifest of one or more additional web resources associated with the resource. In a further still example, updating the template page further comprises accessing at least one of the one or more additional web resources, and wherein displaying the updated template page further comprises using at least one of the one or more additional web resources. In another example, the set of operations further comprises: when it is determined that the request may not be processed using the template page, loading the requested resource in the web-based component. In a further example, caching the template page comprises preparing, based on the template page, a document object model. In yet another example, updating the template page comprises updating at least the document object model with at least part of the received content.

In another aspect, the technology relates to a computer-implemented method. The computer-implemented method comprises: caching, in a web-based component having a request handler, a template page associated with a web application, wherein the template page comprises one or more web resources; receiving, by a hybrid application, a request for a resource; determining, by the request handler, whether the resource is associated with the web application and whether the template page is available to process the request; based on determining that the resource is associated with the web application and that the request may be processed: requesting the resource; receiving, in response to the request, content associated with the resource; updating the template page based on the received content; and displaying, by the web-based component in the hybrid application, the updated template page using at least one of the one or more web resources cached by the web-based component; and based on determining that the request may not be processed using the template page, loading the requested resource in the web-based component. In an example, updating the template page comprises performing an in-place update of the template page based on at least part of the received content. In another example, the content associated with the resource comprises a manifest of one or more additional web resources associated with the resource. In a further example, updating the template page further comprises accessing at least one of the one or more additional web resources, and wherein displaying the updated template page further comprises using at least one of the one or more additional web resources. In yet another example, caching the template page comprises preparing, based on the template page, a document object model. In a further still example, updating the template page comprises updating at least the document object model with at least part of the received content.

In a further aspect, the technology relates to another computer-implemented method. The computer-implemented method comprises: caching, in a web-based component having a request handler, a template page comprising one or more web resources; receiving, by a hybrid application, a request for a resource; determining, by the request handler, that the request for the resource may be processed using the template page in the web-based component; based on determining that the request may be processed: requesting the resource; receiving, in response to the request, content associated with the resource; updating the template page using the received content; and displaying, by the web-based component in the hybrid application, the updated template page using at least one of the one or more web resources cached by the web-based component. In an example, determining that the request may be processed comprises determining whether the template page and the requested resource are associated with a web application. In another example, caching the template page comprises preparing, based on the template page, a document object model. In a further example, updating the template page comprises updating at least the document object model with at least part of the received content. In yet another example, the content associated with the resource comprises a manifest of one or more additional web resources associated with the resource.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
a memory storing instructions that when executed by the at least one processor perform a set of operations comprising:
caching, in a web-based component having a request handler, a template page comprising one or more web resources;
receiving, by a hybrid application, a request for a resource;
determining, by the request handler, whether the request for the resource may be processed using the template page in the web-based component;
when it is determined that the request may be processed:
requesting the resource;
receiving, in response to the request, content associated with the resource;
updating the template page using the received content; and
displaying, by the web-based component in the hybrid application, the updated template page using at least one of the one or more web resources cached by the web-based component.

2. The system of claim 1, wherein determining whether the request may be processed comprises evaluating the request for the resource using pattern matching.

3. The system of claim 1, wherein updating the template page comprises performing an in-place update of the template page based on at least part of the received content.

4. The system of claim 1, wherein the received content associated with the resource comprises a part of the requested resource.

5. The system of claim 1, wherein the content associated with the resource comprises a manifest of one or more additional web resources associated with the resource.

6. The system of claim 5, wherein updating the template page further comprises accessing at least one of the one or more additional web resources, and wherein displaying the updated template page further comprises using at least one of the one or more additional web resources.

7. The system of claim 1, wherein the set of operations further comprises:
when it is determined that the request may not be processed using the template page, loading the requested resource in the web-based component.

8. The system of claim 1, wherein caching the template page comprises preparing, based on the template page, a document object model.

9. The system of claim 8, wherein updating the template page comprises updating at least the document object model with at least part of the received content.

10. A computer-implemented method, the method comprising:
caching, in a web-based component having a request handler, a template page associated with a web application, wherein the template page comprises one or more web resources;
receiving, by a hybrid application, a request for a resource;
determining, by the request handler, whether the resource is associated with the web application and whether the template page is available to process the request;
based on determining that the resource is associated with the web application and that the request may be processed:
requesting the resource;
receiving, in response to the request, content associated with the resource;
updating the template page based on the received content; and
displaying, by the web-based component in the hybrid application, the updated template page using at least one of the one or more web resources cached by the web-based component; and
based on determining that the request may not be processed using the template page, loading the requested resource in the web-based component.

11. The computer-implemented method of claim 10, wherein updating the template page comprises performing an in-place update of the template page based on at least part of the received content.

12. The computer-implemented method of claim 10, wherein the content associated with the resource comprises a manifest of one or more additional web resources associated with the resource.

13. The computer-implemented method of claim 12, wherein updating the template page further comprises accessing at least one of the one or more additional web resources, and wherein displaying the updated template page further comprises using at least one of the one or more additional web resources.

14. The computer-implemented method of claim 10, wherein caching the template page comprises preparing, based on the template page, a document object model.

15. The computer-implemented method of claim 14, wherein updating the template page comprises updating at least the document object model with at least part of the received content.

16. A computer-implemented method, the method comprising:
caching, in a web-based component having a request handler, a template page comprising one or more web resources;
receiving, by a hybrid application, a request for a resource;
determining, by the request handler, that the request for the resource may be processed using the template page in the web-based component;
based on determining that the request may be processed:
requesting the resource;
receiving, in response to the request, content associated with the resource;
updating the template page using the received content; and
displaying, by the web-based component in the hybrid application, the updated template page using at least one of the one or more web resources cached by the web-based component.

17. The computer-implemented method of claim 16, wherein determining that the request may be processed comprises determining whether the template page and the requested resource are associated with a web application.

18. The computer-implemented method of claim 17, wherein caching the template page comprises preparing, based on the template page, a document object model.

19. The computer-implemented method of claim 18, wherein updating the template page comprises updating at least the document object model with at least part of the received content.

20. The computer-implemented method of claim 16, wherein the content associated with the resource comprises a manifest of one or more additional web resources associated with the resource.
